(19) United States
(12) Patent Application Publication
(10) Pub. No.: US 2009/0097853 A1
(43) Pub. Date: Apr. 16, 2009

(54) SHARING VALUE OF NETWORK VARIABLES WITH SUCCESSIVELY ACTIVE INTERFACES OF A COMMUNICATION NODE

(76) Inventors: Anthony L. Sasak, Arlington Height, IL (US); Christopher V. O'Brien, North Aurora, IL (US)

Correspondence Address: DAVIS & ASSOCIATES, P.O. BOX 1093, DRIPPING SPRINGS, TX, 78620, US

(21) Appl. No.: 11/871,973

(22) Filed: Oct. 12, 2007

(51) Int. Cl. H04J 14/08; H04J 3/00; H04L 29/10

(52) U.S. Cl. 398/98; 370/498; 370/216

(57) ABSTRACT

A method includes storing a value of shared variables from a first active packet-to-tdm interface. The value of the shared variables is provided to a successor active packet-to-tdm interface.

### TECHNICAL FIELD

This invention relates to the field of communications. In particular, this invention is drawn to methods and apparatus associated with switching active interfaces for a network.

### BACKGROUND

A communication network typically includes a number of interconnected nodes. Communication between source and destination is accomplished by routing data from a source node through the communication network to a destination node. Such a network, for example, might carry voice communications, financial transaction data, real-time data, etc., not all of which require the same level of performance from the network.

Disruption to the network can be very costly. The revenue stream for many businesses is highly dependent upon the availability of the network. One metric for rating a communication network is the availability of the network for communications.

Redundancy may be used in anticipation of failure of network elements such as links and nodes. In the interest of ensuring the continued availability of the network, some nodes have redundant elements that the communication node may select in the event of a failover. Redundancy for each element, however, might be financially or operationally impractical.

Non-redundant elements represent a single point of failure to uninterrupted traffic flow. Nonetheless, network elements may be designed to ameliorate the impact of such a failure. For example, communication nodes support hot-pluggable replacement of elements to facilitate replacing just the defective components without taking the entire communication node off-line.

Regardless of whether steps are taken to immunize the network from failures either by hot-pluggable elements, redundancies, or both, simply replacing the element or switching to an alternate element may not immediately restore functionality depending upon the nature of the element being replaced.

For example, some elements must inherently interface with other nodes with precise timing constraints. Although nominal or standardized timing values may exist, the actual timing is critical. Even small variations in the timing values utilized by the element may render incoming communications unintelligible or disrupt outgoing communications with another node.

Although approaches exist for learning and tracking the timing values, such approaches may require considerable time (e.g., minutes to hours) of sampling and estimating to converge to the appropriate values. Neither element redundancy nor ease of element replacement adequately immunizes the communication node or the network against costly disruptions to traffic flow as a result of the elapsed time required for re-training the element.

### SUMMARY

One method includes storing a value of shared variables from a first active packet-to-tdm interface. The value of the shared variables is provided to a successor active packet-to-tdm interface.

An apparatus includes a first packet-to-tdm interface and a controller. The first packet-to-tdm interface is an active interface for packet to time-division-multiplexed communications utilizing a first physical location. The controller stores the value of shared variables from the first packet-to-tdm interface. The controller provides the stored value of shared variables to any successor packet-to-tdm interface subsequently utilizing the first physical location.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a network of communication nodes.

FIG. 2 illustrates one embodiment of a communication node.

FIG. 3 illustrates one embodiment of a method of preserving values of shared variables across an interruption in active status of an interface.

FIG. 4 illustrates one embodiment of a rack-based communication node.

FIG. 5 illustrates one embodiment of a method of communicating the value of shared variables from a primary packet-to-tdm interface to a secondary packet-to-tdm interface.

FIG. 6 illustrates one embodiment of a method of communicating the value of shared variables from a first packet-to-tdm interface to a successor packet-to-tdm interface.

FIG. 7 illustrates one embodiment of the method of FIG. 6.

### DETAILED DESCRIPTION

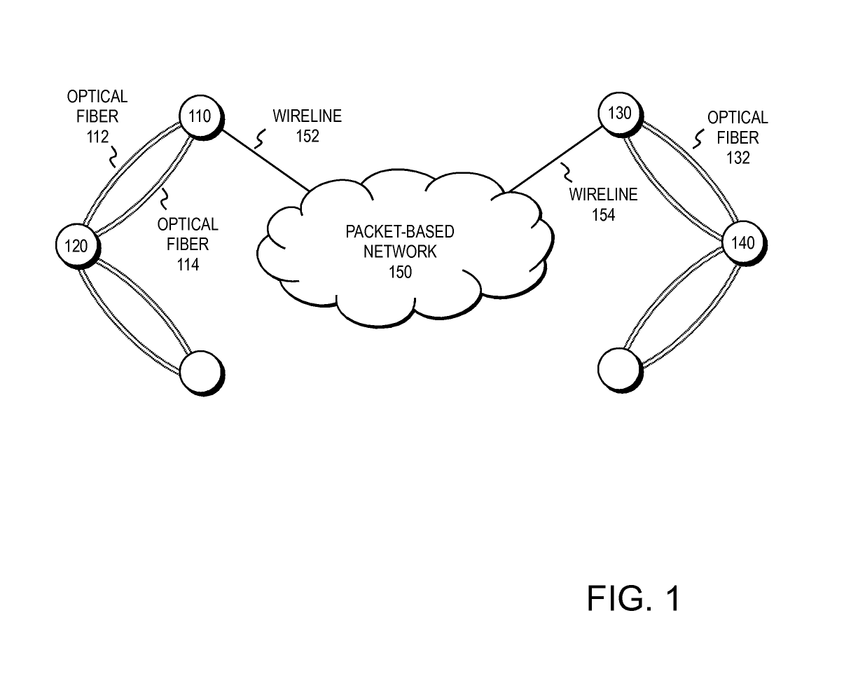

FIG. 1 illustrates one embodiment of a communications network including a plurality of communication nodes 110, 120, 130. The illustrated links 112 may be any media including wireless, wireline, optical fiber, etc. In addition, the communication node may receive communications on a link observing one protocol while transmitting communications on another link observing a different protocol. Nodes supporting multiple protocols are referred to as multi-service nodes.

For example, nodes 110, 120 may communicate via an optical fiber link 112, 114. Node 110 may communicate with another node 130 via wireline links 152, 154, and network 150. Network 150, for example, may represent a packetized data communication network.

Although the protocols used for communication are not necessarily dictated by the physical media, in the illustrated embodiment data carried by wirelines 152, 154 is packetized and data carried by the optical fibers utilizes time-division-multiplexing (TDM). In addition to TDM, wavelength division multiplexing (WDM) may be utilized to enable optical fibers to carry multiple optical paths simultaneously. WDM assigns each optical path to a different optical wavelength for communication by the optical fiber.

Due to the changes in protocol, the nodes may need to engage in protocol conversion in order to effectively communicate with other nodes. Thus node 110 may receive packetized data on one link 152 from one node 130. That packetized data must be converted by node 110 to TDM data for communication to another node 120 via a link 112 that relies upon TDM protocols.

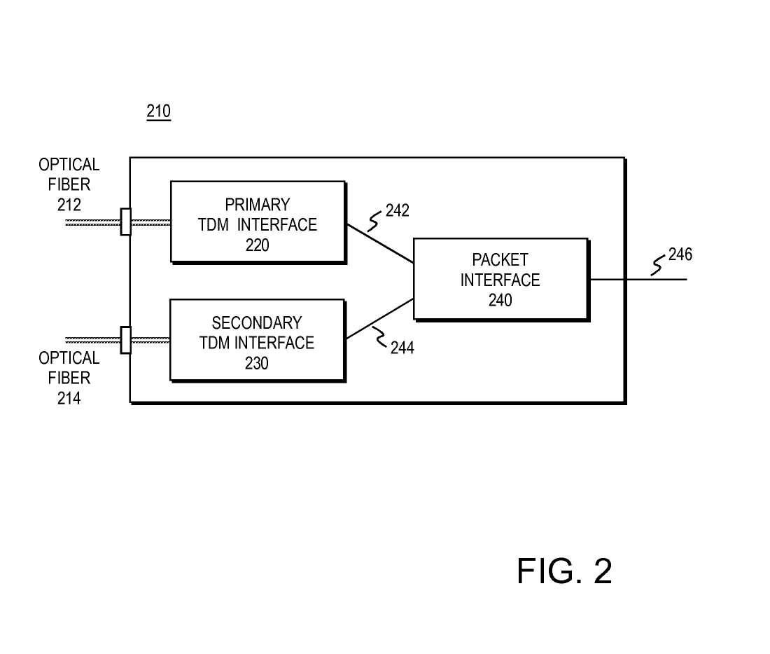

FIG. 2 illustrates one embodiment of a communication node 210. In the illustrated embodiment, the node includes a packet interface 240 and one or more TDM interfaces 220, 230. The packet interface handles receipt of packets from a packet based network 246. The packet interface is coupled 242, 244 to provide packets to the TDM interfaces 220, 230. The TDM interfaces handle protocol conversion from packet-to-tdm and will alternatively be referred to as the packet-to-tdm interfaces.

The secondary TDM interface 230 is a redundant interface. Only one of the primary and secondary interfaces is active in protocol conversion and communication. The other interface is inactive until a fault is detected with the then-active interface in which case a switchover is used to restore functionality with an objective of minimizing disruption to data traffic.

In the illustrated embodiment, the TDM interface is optical. The optical links 112 may form a portion of a Synchronous Optical Network (SONET) or a Synchronous Digital Hierarchy (SDH) optical network.

In one embodiment, one of two systemic failures is anticipated for the packet-to-tdm interfaces 220, 230. The primary fiber optic line 212 may be severed. If so, then simply transmitting on the secondary fiber optic line 214 may suffice to solve the problem. In such cases, the packet-to-tdm conversion may still take place on the primary TDM interface 220 with a “bridge” to the secondary TDM interface 230 for generation and transmission of the optical signal. This solves two potential points of failure for a selected interface—a severed fiber or a nonfunctional optical driver. The protocol conversion portions of the primary interface are presumed to be functional in this case.

If the packet-to-tdm processing is rendered nonfunctional, the interface may be deemed to have failed. In such cases, a complete switchover to a redundant interface may solve the problem. The redundant interface replaces the original interface as the “active” interface. In the illustrated embodiment, switching interfaces also selects a different optical fiber. This switchover approach allows data traffic to be handled even in the event of a severed fiber, nonfunctional optical driver of the then-active TDM interface, or a failure in the protocol conversion portions of interface. The redundant interface is thus a “protection” interface used to protect the traffic carrying capabilities of the active or “protected” interface.

The process of designating protection and protected interfaces as well as handling the switchover is referred to as Automatic Protection Switching (APS) in the context of SONET communications. The international counterpart for SDH is Multiplex Section Protection (MSP). The redundant interface is a “protection” interface that is used as a backup for the active “protected” interface. The protection interface assumes the traffic load of the active interface and thus should be capable of supporting the same capacity as the protected interface. The “protection” interface will be more generally referred to as the successor interface.

Despite provisioning for high speed switching to a successor interface, the active node maintains the value of one or more variables that may be “learned” over the course of time while participating in network communications. The packet arrival rate, packet exit rate, errors, and statistical distributions of these variables are examples of the types of information that can be measured or derived from actual network traffic.

The packet-to-tdm interface might identify particular types of statistical distributions (e.g., Gaussian) and determine variable values that define the distributions (e.g., mean, standard deviation or variance, etc.) and various characteristics of the incoming data for purposes of regulating the packet-to-tdm conversion process.

In one embodiment, the packet arrival rate is modeled, for example, with a Gaussian distribution while the distribution of the size of the packets is modeled with a Pareto distribution (in the case of varying packet sizes). In alternative embodiments, different types of statistical distributions or one or more characteristics (e.g., arrival rate, packet size, etc.) may be substantially fixed in value.

The variable values are determined from observation of incoming packets and thus take time to learn and begin tracking. These values may be necessary for controlling the packet-to-tdm conversion process or handling other traffic flow issues.

The packet-to-tdm interfaces control the rate at which packet data is “played out” from a packet buffer to create TDM data. In order to meet a constant bit rate while not allowing queues to become empty or overflow, the packet-to-tdm interface may insert “dummy” packets or vary the number of bytes associated with a packet, etc.

Although there may be some nominal variable values established as a standard, the communication node has constraints based upon the need to interact with other communication nodes in the network. Accordingly, the actual value rather than a nominal value for variables that dictate the rate at which packet data is “played out” from a packet buffer to the TDM interface is of paramount importance. Expected changes to these values over time can also be quantified. Large, sudden changes cannot be made in an attempt to converge to the correct value without introducing jitter into other communication nodes in the network.

Consider the case where packets correspond to DS1-rate communications and the node or TDM network has the bandwidth to handle up to m channels. All incoming packets are placed into a packet buffer. Incoming packets belong to 1 of m DS1-rate channels. Each channel is assigned a particular time slot in the TDM interface. The arrival rate of packets for any particular channel may be different than the arrival rate of packets for other channels. Thus variable values for individual channels need to be tracked by the active interface (e.g., for a given variable, a value per channel up to m channels may be tracked). The variables may be referred to as “link,” “circuit,” or “channel” variables.

The value for some of these variables may require considerable time to identify and track across all channels. After an interruption in active status, a successor packet-to-tdm interface may be useless for communication until the value of these variables can be precisely determined. As a result, a fast switch to a redundant element may not be sufficient to minimize interruptions to communications traffic. The availability of these variable values to the successor interfaces, however, may significantly shorten or even substantially eliminate interruptions beyond the time required to switch active status between one or more interfaces.

One approach is to store the value of the variables in a manner such that they persist across changes of active status. The value of the variables as they existed may be shared with successor interfaces such that they are available to redundant interfaces or even the same interface subsequent an interruption in active status. This persistency allows the value of the variables to be shared by an active interface with a successor active interface that may be a different or the same active interface.

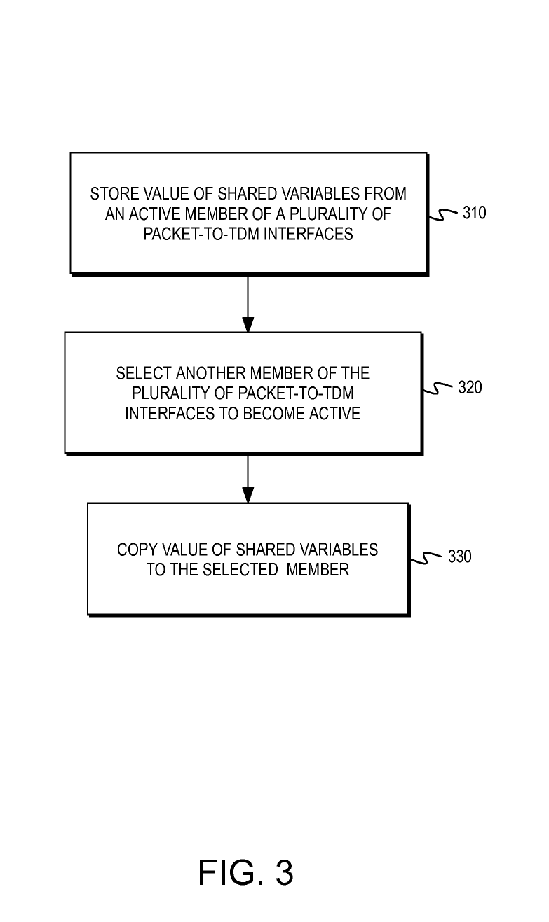

FIG. 3 illustrates one embodiment of a method of maintaining values of shared variables for a plurality of packet-to-tdm interfaces. Values of shared variables from an active member of a plurality of packet-to-tdm interfaces is stored in step 310. Another member of the plurality of packet-to-tdm interfaces is selected to become active in step 320. The value of shared variables is copied to the selected member in step 330. The active status is an exclusive status within the protection group. At most only one member of a protection group may have an active status.

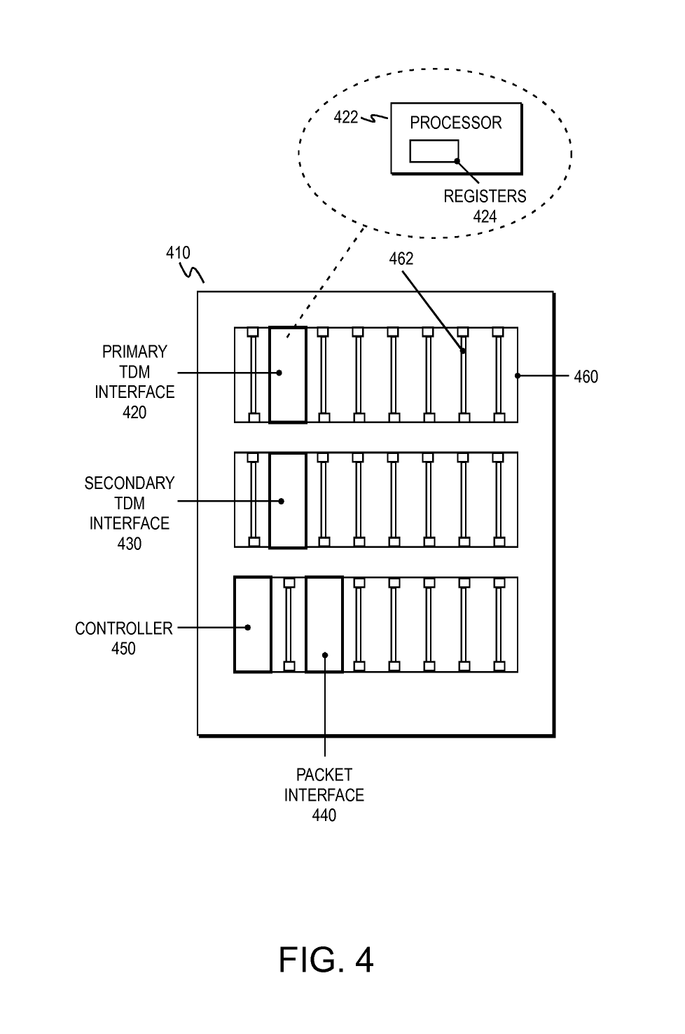

For a practical application of this method, consider the embodiment of a multi-service communication node illustrated in FIG. 4. The communication node is physically embodied as a rack 410. The rack includes a plurality of shelves 460. Each shelf supports one or more modules that can be inserted into and removed from slots such as slot 462.

In the illustrated embodiment, packet interface 440, primary TDM interface 420 (optical), and secondary TDM interface 430 (optical) are inserted on different shelves. Primary TDM interface 420 is the protected interface and secondary TDM interface 430 is the protection interface. In the rack context, interfaces 420, 430, and 440 are referred to as pluggable line modules (PLM). In one embodiment, the primary and second TDM interfaces serve as packet-to-tdm interfaces. In alternative embodiments, the packet-to-tdm conversion functionality is distributed across one or more other pluggable modules. A controller 450 manages communication between the line modules as well as the operation of the line modules. The rack has a backplane to support communication between the line modules. In addition, cables may be used to connect the modules.

The controller supervises the system. The controller tracks the modules having active status, maintains protection groups, and determines when to switch to another member of the protection group for handling traffic. The controller may proactively determine that a currently active module should become inactive and another module should become the active module. This may occur, for example, through detection or signaling of a failure or erratic behavior in the active module.

The illustrated configuration offers several approaches to sharing variables among the modules forming a protection pair. The modules in the protected group may proactively obtain the data from each other or from a shared location. Alternatively, the data may be “pushed” onto modules from a shared location. Given the planning for failure, the shared location in one embodiment is not located physically on any of the modules of a protection group.

In one embodiment the controller tracks the shared variables. The controller copies the value of the shared variables to the module designated to become the next active module either prior to or subsequent selection of the successor module as the active module. The values of the shared variables may be accessible, for example, as registers that the controller can read from or write to modules. Typically each PLM has a processor 420 controlling its operation. The processor has one or more registers 424.

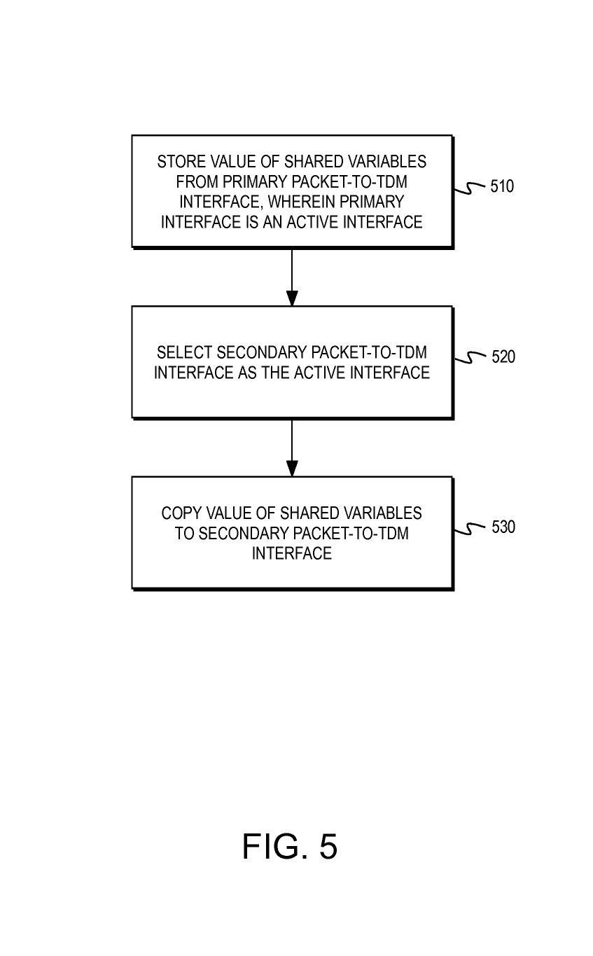

FIG. 5 illustrates one embodiment of the method of FIG. 3 applied to the communication node of FIG. 4. The protection group consists of two modules. The protection group is thus a protection pair. At 510, the value of shared variables from the primary packet-to-tdm interface is stored. The primary interface is the active interface. In one embodiment, the controller is responsible for proactively retrieving and storing the value of the shared variables. The physical storage location may reside within the controller, another location within the rack, or external to the rack.

In one embodiment, the active interface signals the controller to indicate changes to the value of the shared variables such that store operations can be avoided if there are no updates to the value(s). Alternatively, the controller may periodically read or request the current value of the shared variables.

The secondary packet-to-tdm interface is selected as the active interface at 520. The value of the shared variables is copied to the secondary interface at 530. The order of these operations may vary depending upon the configuration. For example, copying to the secondary interface may take place prior to actual designation of the secondary interface as the active interface.

In one embodiment, the controller tracks a “last valid” set in addition to a current set of values for the shared variables. There is a possibility that the tracking functionality of the packet-to-tdm interface may become unreliable prior to failure or prior to recognized failure of the active element. Alternatively, rapid fluctuations in these values may suggest that the active element has failed and is no longer responding properly in accordance with the established values. Accordingly, one would utilize the last valid set as opposed to the most recent set of values for the shared variables.

Although the determination of the appropriate standards for determining when values should be adopted as the “last valid” set may depend upon the specific application or network environment, objective criteria that might be considered include: the amount of individual change in one or more variables, a collective amount of change in the shared variables, the number of variables changing value, the length of time between changes, or the value of one or more variables. In various embodiments, more than one update of these values may be maintained in order to determine if a particular set should be adopted as the last valid value set. In other embodiments, the current value set is presumed to be the last valid set of values.

In some cases, there may not be a redundant element to switch to. This may occur, for example, due to a previous malfunction that left the currently active element as the only functioning element of a protection group. In other cases, the interface functionality may have been planned or configured without redundancy. Restoration of service requires substitution or repair and replacement. Each of these operations requires removing the existing interface that results in suspending the active status. Re-installation of the same interface or a substitute may result in restoration of the active status. Such operations result in an interruption of the active status but not necessarily switching the active status to a distinct interface. Thus values of the shared variables may be shared across an interruption in active status that may not coincide with an actual change in interface modules.

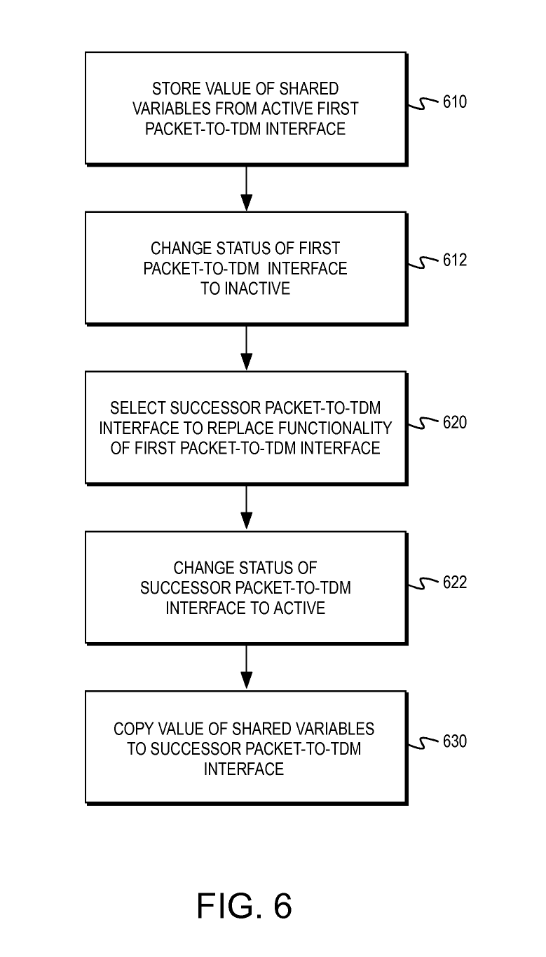

FIG. 6 illustrates one embodiment of a method of sharing variable values across an interruption in active status. The value of the shared variables from an active first packet-to-tdm interface is stored at 610. The status of the first packet-to-tdm interface is changed to inactive at 612. A successor packet-to-tdm interface is selected to replace the functionality of the first packet-to-tdm interface. The status of the successor packet-to-tdm interface is changed to active at 622. The value of the shared variables is copied to the successor packet-to-tdm interface at 630.

When a redundant interface co-exists in the communication node, re-establishing active status with the redundant interface may occur quickly. When there is no redundant interface residing in the communication node, re-establishing active status is limited by the time required to repair or replace the existing interface.

Irrespective of the existence of redundant interfaces, the method of FIG. 6 ensures that the value of the shared variables persists across interruptions in active status so that the value is available for use by the successor active interface. The method of FIG. 6 is applicable regardless of whether a) the successor interface is an interface distinct from the first interface and co-existing in the node with the first interface, b) the successor interface is an interface distinct from the first interface but not co-existing in the node with the first interface, or c) the successor interface is the same as the first interface.

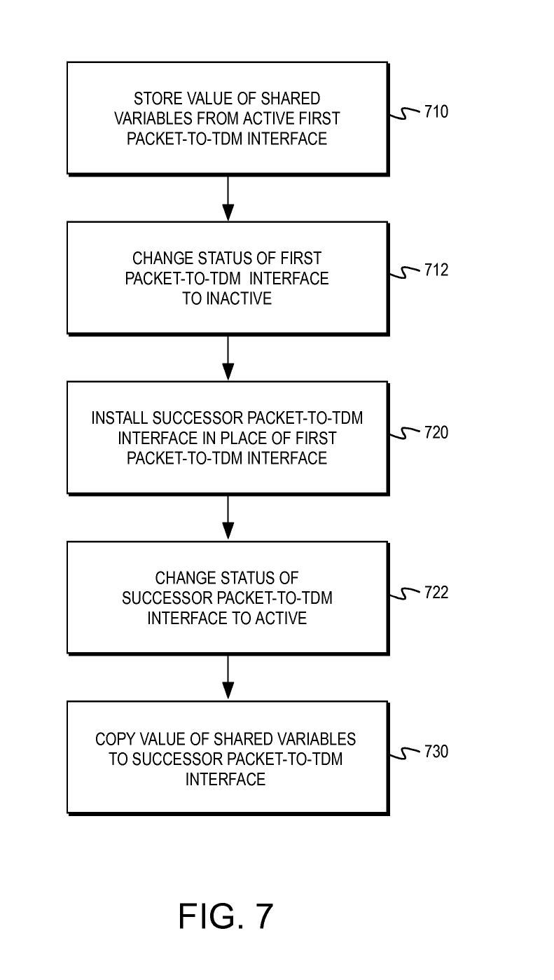

FIG. 7 illustrates one embodiment of the method of FIG. 6 when there is no redundancy. The value of the shared variables from an active first packet-to-tdm interface is stored at 710. The status of the first packet-to-tdm interface is changed to inactive at 712. The first packet-to-tdm interface is removed to permit installation of a successor packet-to-tdm interface at 720. The successor packet-to-tdm interface may be the first packet-to-tdm interface. The successor packet-to-tdm interface utilizes a same physical location formerly used by the first packet-to-tdm interface. The status of the successor packet-to-tdm interface is changed to active at 722. The value of the shared variables is copied to the successor packet-to-tdm interface at 730.

When redundant interfaces exist, the active interface may be removed with minimal disruption. The preservation of the variable values for use by the redundant interface enables the redundant interface to avoid the lengthy re-training process when it becomes the active interface.

In the case of no redundant interfaces, the active interface may be removed and either replaced or re-inserted. As long as active status is restored within a reasonable time the re-training process can be avoided. The interruption to traffic flow is limited substantially to the amount of time that the interface is removed because the preservation of the variable values across interruptions in active status enables the interface to avoid the re-training process.

Thus modules may now be removed or replaced for purposes of preventive maintenance or upgrades while limiting the interruption to traffic flow that would otherwise occur. Although specific embodiments have been illustrated with respect to TDM interface modules, the disclosed methods may be applied to interface modules supporting other protocols or even modules that do not directly serve in an interface role.

In the preceding detailed description, the invention is described with reference to specific exemplary embodiments thereof. Various modifications and changes may be made thereto without departing from the broader scope of the invention as set forth in the claims. The specification and drawings are, accordingly, to be regarded in an illustrative rather than a restrictive sense.

What is claimed is:

1. A method comprising:
a) storing values of shared variables from a first active packet-to-tdm interface;
b) providing the value of the shared variables to a successor active packet-to-tdm interface.

2. The method of claim 1 wherein the first and successor packet-to-tdm interfaces are the same interface.

3. The method of claim 1 wherein the value of the shared variables is provided to the successor active packet-to-tdm interface after the successor active packet-to-tdm interface becomes active.

4. The method of claim 1, wherein the value of the shared variables is provided to the successor active packet-to-tdm interface prior to the successor active packet-to-tdm interface becoming active.

5. The method of claim 1 wherein the first and successor active packet-to-tdm interfaces are pluggable modules, the method further comprising:
c) replacing a first pluggable module corresponding to the first active packet-to-tdm interface with a second pluggable module corresponding to the successor packet-to-tdm interface, wherein the second pluggable module utilizes the same physical location utilized by the first pluggable module prior to replacement.

6. The method of claim 5 wherein the first and second pluggable modules are the same pluggable module.

7. The method of claim 5 wherein the first and second pluggable modules are distinct pluggable modules.

8. The method of claim 1 wherein the active packet-to-tdm interface communicates time division multiplexed data optically.

9. The method of claim 1 wherein the packet-to-tdm interfaces communicate packet data electrically.

10. The method of claim 1 wherein a) comprises storing the value of the shared variables in a physical location external to the active packet-to-tdm interface.

11. An apparatus comprising:
a first packet-to-tdm interface, wherein the first packet-to-tdm interface is an active interface for packet-to-time-division-multiplexed communications utilizing a first physical location; and
a controller, wherein the controller stores a value of shared variables from the first packet-to-tdm interface, wherein the controller provides the stored value of shared variables to any successor packet-to-tdm interface subsequently utilizing the first physical location.

12. The apparatus of claim 11 wherein the first packet-to-tdm interface is physically distinct from the successor packet-to-tdm interface.

13. The apparatus of claim 11 wherein the first packet-to-tdm interface is the successor packet-to-tdm interface.

14. The apparatus of claim 11 wherein the values are retrieved from registers of the first packet-to-tdm interface and provided to registers of the successor packet-to-tdm interface.

15. The apparatus of claim 11 wherein the first and successor packet-to-tdm interfaces communicate time division multiplexed data optically.

16. The apparatus of claim 11 wherein the first and successor packet-to-tdm interfaces communicate packet data electrically.
